(19) United States
(12) Patent Application Publication
(10) Pub. No.: US 2005/0147797 A1
(43) Pub. Date: Jul. 7, 2005

(54) Device and method for joining layers for forming sheet products and resulting products

(76) Inventors: Guglielmo Biagiotti, Lucca (IT); Alessandro Morelli, Lucca (IT); Angelo Benvenuti, Lucca (IT)

Correspondence Address: BREINER & BREINER, 115 NORTH HENRY STREET, P. O. BOX 19290, ALEXANDRIA, VA, 22314, US

(21) Appl. No.: 10/510,515

(22) PCT Filed: Apr. 7, 2003
(86) PCT No.: PCT/IT03/00211

(30) Foreign Application Priority Data
Apr. 12, 2002 (IT) FI2002A000061

(51) Int. Cl. B32B 3/00

(52) U.S. Cl. 428/172

(57) ABSTRACT

The device comprises an essentially rigid smooth first cylinder (1) and an essentially rigid second cylinder 83), the latter having points (3P), the first and second cylinders rotate in opposite directions about respective axes of rotation (1A, 3A) and are pressed against each other, thus defining between themselves a lamination nip (5), through which said at least two layers are passed. There is also a pressure roller 87), with a surface (7A) that is less rigid than the first and second cylinders (1, 3), this roller interacting with the second cylinder and being pressed against it. The pressure roller forms with the second cylinder (3) an embossing nip (9) through which the layers (V1, V2) previously laminated in the lamination nip (5) are passed and in which they are embossed.

### TECHNICAL FIELD

The present invention relates to a device for joining two or more layers of a web material, of fibrous material, for example, especially so-called tissue paper, nonwovens for the production of table napkins, handkerchiefs, cloths or other multilayer folded sheet products.

The invention also relates to a method for joining two or more layers for the abovementioned purposes.

### STATE OF THE ART

An important part of the tissue paper conversion industry is to do with the production of folded products, i.e. those products which are obtained by cutting and folding portions of a continuous web material. Table napkins, handkerchiefs, tablecloths and other similar products are packaged and sold in this form.

Very often the folded products consist of two or more layers of fibrous material, such as a nonwoven, a tissue paper or the like, joined together. Two joined layers are typically used. In particular, in the production of paper tablecloths the two layers intended to form the finished product are joined while still in the form of a continuous web material. Two continuous layers are brought together and fed through a nip formed by two cylinders pressed against each other. One of said two cylinders has a smooth hard and relatively rigid surface, typically made of steel or other material having suitable strength and hardness. The second cylinder is also made of a hard rigid material, typically steel, but its surface includes a series of protuberances distributed appropriately to join the layers together and create a decoration on the product.

Shown schematically in FIG. 1 is a device of known type. The reference number 1 denotes a first cylinder rotating as indicated by the arrow F1 about an axis 1A and made of steel with a smooth cylindrical surface 1S. The number 3 denotes the second steel cylinder rotating as indicated by the arrow F3 about an axis 3A and having a surface that includes a series of protuberances or points 3P. The two cylinders define a lamination nip 5 through which two layers V1, V2 of paper material, such as tissue paper, pass and are laminated and joined between the two cylinders to form a web product N.

In the nip 5 the two layers V1 and V2 undergo high pressure at the points 3P of the cylinder 3 as the two cylinders 1, 3 are pressed together. Typically, for a pair of rollers with an axial length of 600-650 mm the force with which they are pressed together is of the order of 5000-6000 kg. The high pressure generated at the points 3P, between the points and the smooth surface of the cylinder 1, produces a ply-bonding effect, that is to say a localized mutual adhesion of the two layers due to a mingling of the fibers of the two layers, a phenomenon familiar to those skilled in the art and used to unite two layers of paper without adhesive. At the same time the points 3P produce a slight embossing of the paper material which serves to decorate the finished product.

FIG. 2 shows a schematic enlargement of the area of lamination of the layers between the cylinders 1 and 3. FIG. 3 shows schematically a local cross section through the web material N taken on a plane perpendicular to the axes 1A and 3A. The letter P denotes the protuberances generated on the layer V2 by the points 3P, protuberances which are directed toward the layer V1, that is into the product. At the tops of the protuberances is the area C of fiber compression and mingling.

An example of a device of this type is disclosed in EP-A-1 151 852.

This laminating technique, which produces a ply-bonding of the layers, takes the name top-to-flat embossing, which is intended to indicate the fact that the peaks of the points of one cylinder act on the smooth surface of the other cylinder. The cylinders, being rigid, do not deform when pressed against each other in the lamination area, despite the high pressures.

The points 3P are distributed over the surface of the cylinder 3 in bands that are longitudinal (that is parallel to the axis 3A) and circumferential (that is annular), to generate areas of embossing and ply-bonding which will be situated along the four edges of the table napkins produced by cutting the web material N longitudinally and transversely. FIG. 4 shows a plan view of a portion of the web material. The embossing and ply-bonding produced by the points 3P of the cylinder 3 is present in the shaded area marked with a G. The references LL and LT indicate the longitudinal and transverse cut lines, respectively, along which the web material N will be cut to form the individual products. FIG. 4A shows in opened-out form a product M obtained from the continuous web material N after cutting. B1, B2, B3 and B4 are the four edges of the product, along which runs the embossed band G. P1 and P2 denote the fold lines along which the product M is folded. The folded product is shown in FIG. 5. In the folded product the embossed band G runs along two of the four sides of the product. Folding is done in such a way that the layer V2 is on the outside of the folded product. This is because this layer has a better aesthetic appearance than the layer V1, owing to the particular type of lamination which it undergoes.

It has been found that the high pressure exerted by the points 3P and by the cylindrical surface 1S on the two layers, which produces the embossing and lamination and/or ply-bonding of the layers, has two unwanted side effects. On the one hand the apparent thickness of the product M is less along its edges (that is along the band where the pressure of the points 3P was exerted) than in the center. Secondly, the margins of the product tend to curl up and therefore the corners A1 and A2 of the folded product (FIG. 5) tend to lift. Both of these phenomena are due to the configuration of the cylinders, to their rigidity and to the high pressure applied to the layers.

What happens is that, unlike normal embossing processes, where the layers are squeezed between the rigid cylinder with points and a resilient pressure roller, so that the layers are deformed to a substantial extent and their volume increased, in lamination between two rigid cylinders such as 1 and 3 there is a squeezing of the laminated layers. Furthermore, the layer V2 undergoes a slight deformation that causes its surface area to reduce. Because the two layers V1 and V2 are united at the points 3P by the laminating action, the shortening of one layer compared with the other causes the product composed of the joined and cut layers to curl, with a lifting of the margins toward the face formed by the layer V2.

Because the product is folded in such a way that the layer V2 is on the outside, its corners tend to lift. The effect is greater the larger the dimensions of the product. Also, because the layers are laminated in areas which in the finished product are situated along the edges, the folded product will have areas of variable thickness.

These two effects cause various problems at the packaging stage. Specifically, when a number of products M are stacked to form a pack PM of products which is then to be packaged, as shown in FIG. 6, the total thickness of the pack is less along two peripheral areas, corresponding to the position assumed by the laminated portions G. The irregular shape of the pack of products causes difficulties for the packaging machines. Also, the tendency of the corners of the two outermost napkins to lift means that in some cases they are folded back on the outer surface of the stack, causing a defect in the packaging, which must then be rejected.

Moreover, the tendency of the margins of the napkins to lift causes difficulties as they leave the folding machines, where individual packs of table napkins (each containing a precise number of products M) must be separated in order to be transferred to the packaging machine.

### OBJECTS AND SUMMARY OF THE INVENTION

It is an object of the present invention to provide a device and a method that will overcome all or some of the drawbacks explained above.

In essence, the invention provides a device comprising an essentially rigid smooth first cylinder and an essentially rigid second cylinder, the latter having points, these cylinders defining between themselves a lamination nip through which the layers are passed and in which the cylinders are pressed against each other, which device is characterized in that it comprises a pressure roller, with a surface that is less rigid than said first and second cylinders, this roller interacting with the second cylinder. The pressure roller is located on the path of the web material around the second cylinder downstream of the lamination nip and forms with said second cylinder an embossing nip. The layers previously laminated in the lamination nip are passed through the embossing nip and are thus subjected, after being laminated, to an embossing action.

As will be clear from the description of an illustrative embodiment, the embossing to which the layers are subjected after being laminated deforms and therefore lengthens both layers. This restores the original apparent thickness of the web material, and eliminates the tendency of the product, obtained after cutting up the web material, to curl.

It has also been observed that the superimposition of the embossing produced by the pressure roller on the lamination previously applied to the two layers improves the overall aesthetic appearance of the product.

The pressure roller may be covered with any material of suitable resilience, such as rubber or other material.

With a device of this type it is possible to carry out a method for producing a web product comprising at least a first layer and a second layer, in which the first and second layers are united by lamination in a nip between an essentially rigid smooth first cylinder and an essentially rigid second cylinder, the latter having points, the method being characterized in that the two layers united by lamination are embossed between said second cylinder and a pressure roller whose surface is more resilient than the surface of said first and second cylinders.

The protuberances embossed onto the two layers may have a height of for example 0.1 and 1 mm, although this should not be taken to be binding and limiting. Generally speaking the depth decided upon for the embossing and hence for the height of the protuberances generated on the paper material will be such as to obtain the desired effect of compensating for the change of thickness caused in the previous phase of lamination or ply-bonding and in such a way as to reduce or eliminate the tendency of the margins of the cut products to curl up.

A method of this kind produces a sheet product comprising at least two layers united along peripheral bands by mutual mingling of the fibers of the layers due to the localized compression of areas or points distributed to form a particular design corresponding to the distribution of the points on the second cylinder. Characteristically, the product possesses, superimposed on the local mingling (that is to say, mingling confined to certain areas) of the fibers of the two layers, embossing on both layers. This embossing is generated in a design coinciding with the design defined by the areas or spots of local mingling of the fibers because it is produced by the same points as gave rise to the lamination or ply-bonding by which the layers were united.

The points on the rigid cylinder may be distributed to form any design. For instance, points may be disposed in helical alignments so as to produce protuberances in straight lines on the product. However, it is also possible to distribute them in curved lines to produce more or less complex designs, with curvilinear patterns, on the product.

The resilience of the material covering the pressure roller may also be such as to generate other embossed designs on the two layers additional to the designs produced in the areas of lamination or ply-bonding because, in addition to the points that interact with the smooth cylinder to laminate or ply-bond two layers and so unite them, the rigid second cylinder may also be provided with additional points lower than the previous points, which will therefore not press against the smooth cylinder but will still interact with the surface of the pressure roller simply because it is more resilient. In the embossing nip the points which in the lamination nip caused the fibers of the two layers to fuse penetrate to a certain depth, embossing the two layers with a design coinciding with that of the lamination, while the additional points on the cylinder penetrate slightly less far into the resilient surface of the pressure roller, but still far enough to emboss both layers.

### BRIEF DESCRIPTION OF THE DRAWINGS

A clearer understanding of the invention will be gained from the description and the accompanying drawing, the latter showing a practical, non-restrictive embodiment of the invention. More particularly, in the drawing:

FIG. 1 shows (as already described) a device according to the prior art;

FIG. 2 shows an enlargement of the area of lamination between the cylinders;

FIG. 3 shows a schematic and enlarged section through the web material as it leaves the lamination nip between the two cylinders of the device;

FIG. 4 shows a plan view of a portion of web material as it leaves the device;

FIG. 4A shows a product spread out;

FIG. 5 shows the product folded;

FIG. 6 shows a pack of products ready for packaging;

FIG. 7 shows a diagram of a device according to the invention;

FIG. 8 shows a schematic enlargement of the embossing area downstream of the nip between the two steel cylinders; and

FIG. 9 shows an enlarged schematic local cross section through the web material as it leaves the device shown in FIG. 7.

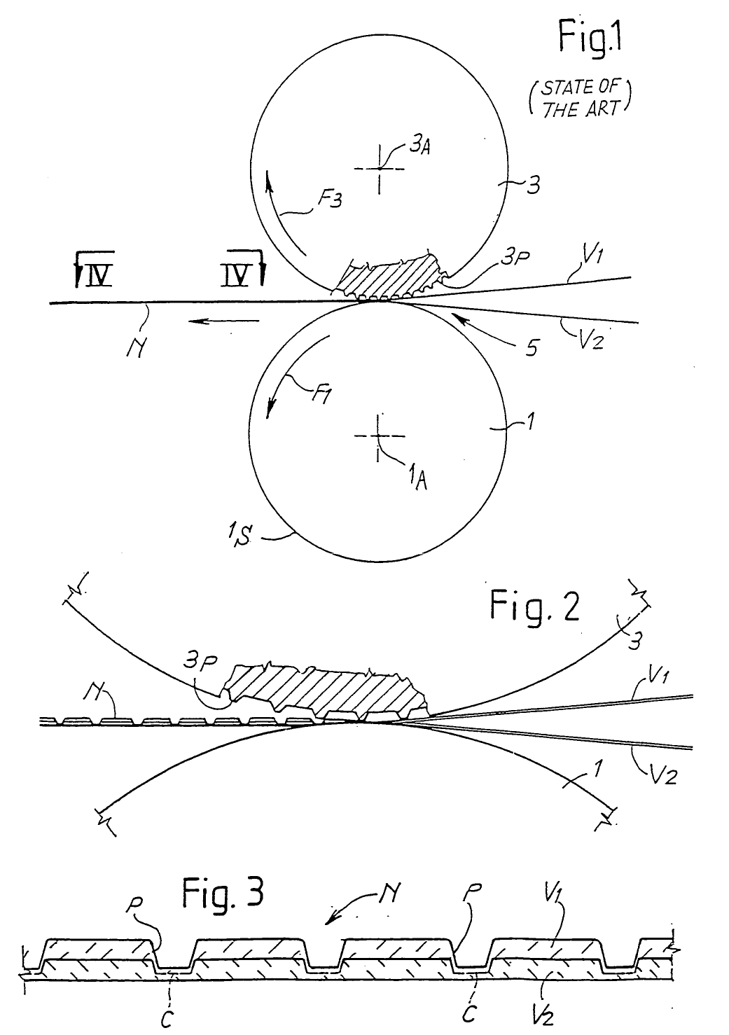

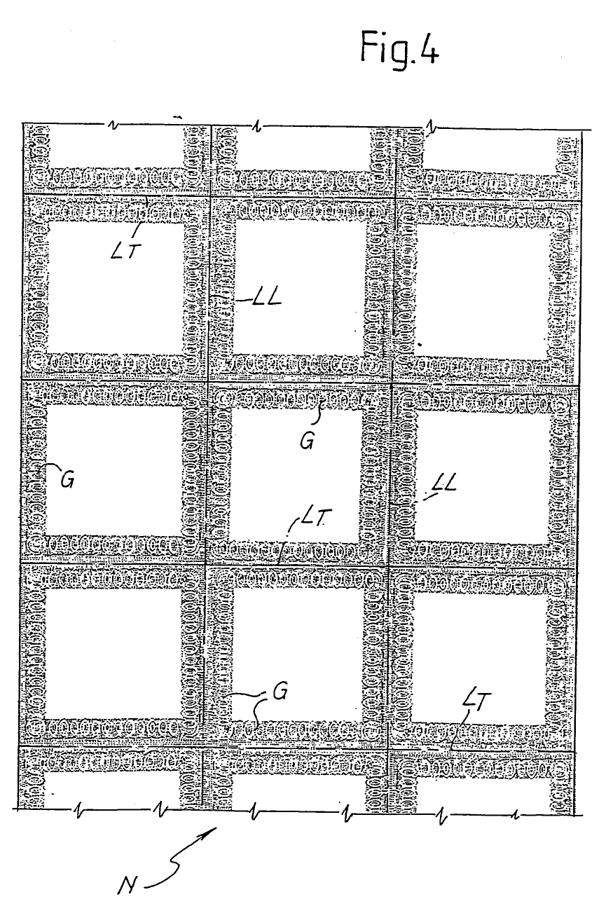

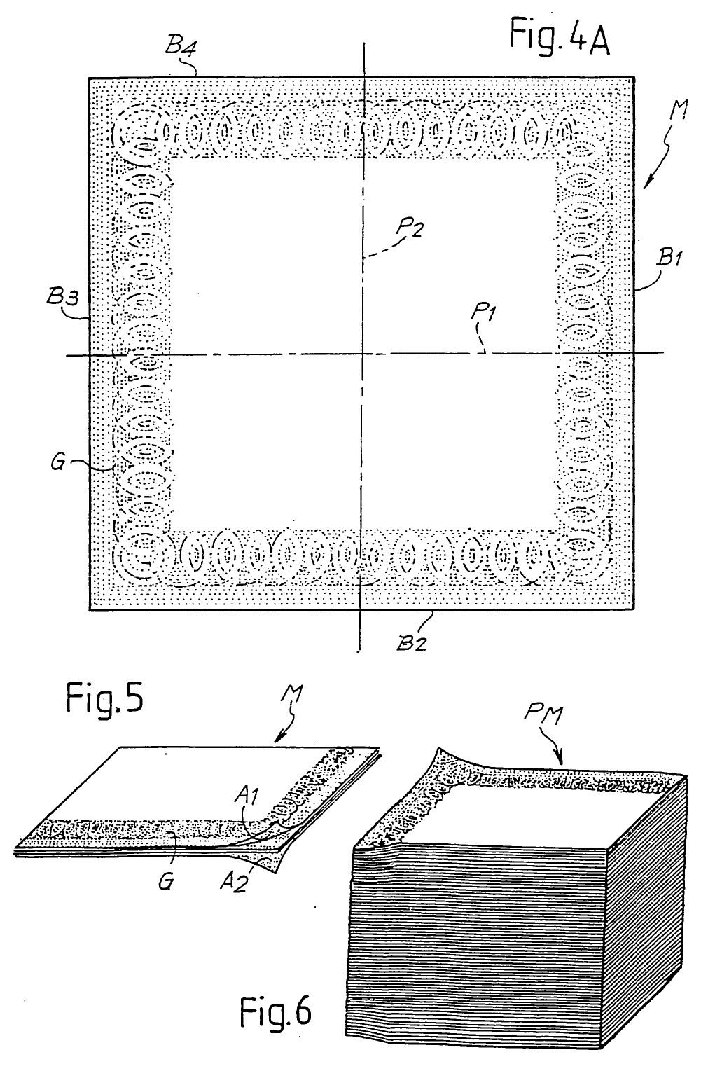

### DETAILED DESCRIPTION OF THE PREFERRED EMBODIMENT OF THE INVENTION

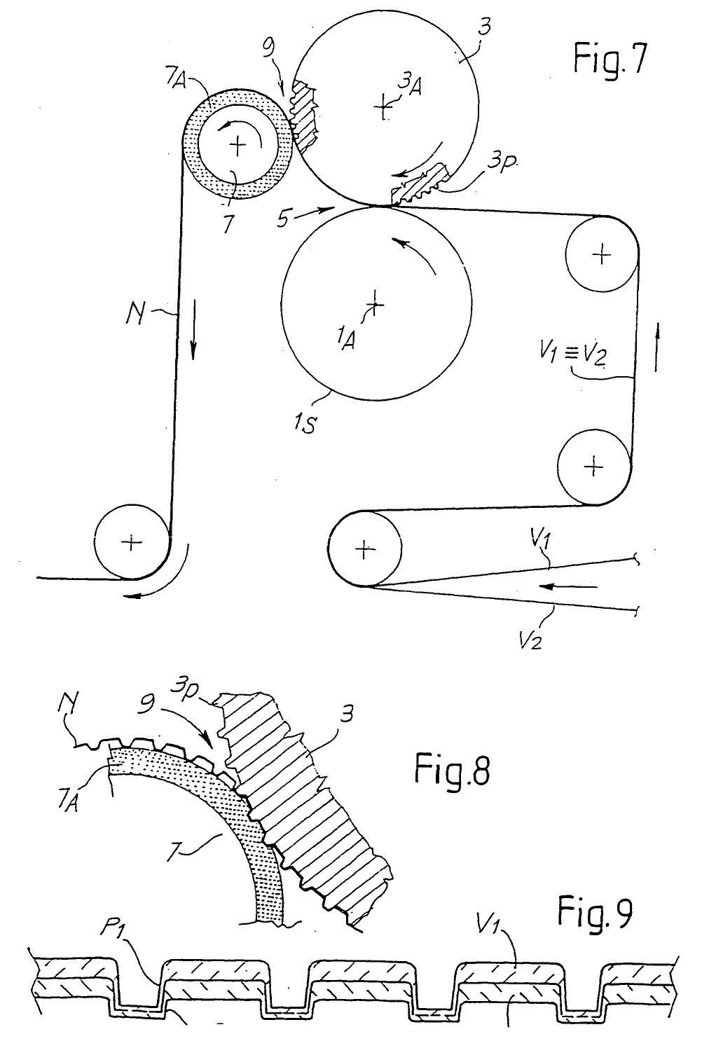

FIG. 7 shows schematically one embodiment of the device according to the invention. Identical numbers denote parts identical or corresponding to those of FIG. 1 described earlier with reference to the prior art. 1 and 3 again denote the first and second cylinders, made of steel or other hard and relatively rigid material. 1A and 3A denote the two axes of rotation; 1 S the essentially smooth cylindrical surface of the cylinder 1; and 3P the points of the cylinder 3. 5 denotes the lamination nip between the cylinders 1 and 3, through which the two layers V1 and V2 pass, being joined in this nip to form the web material N.

The distribution of the points 3P on the cylinder 3 is similar to that described with reference to FIG. 1.

Characteristically, according to the invention, along the path of the web material N, downstream of the nip 5 is a pressure roller 7 with a covering 7A of resilient material such as rubber. Between the pressure roller 7 and the cylinder 3 a second nip 9 is defined, through which the web material N passes. This nip will be termed with embossing nip.

Because the roller 7 is covered with resilient material, the points 3P of the cylinder 3 deform the covering of this roller and penetrate into it, producing a distinct embossing of the web material N as it passes between them, as shown in the schematic enlargement, FIG. 8.

This embossing has the following effect: the web material N leaving the lamination nip 5 between the cylinders 1 and 3 has the appearance sketched in FIG. 3, described above, with the layer V1 largely undeformed in a direction perpendicular to the layer itself, while the layer V2 is slightly deformed and has protuberances P pointing toward the layer V1, with the areas of mingling or adhesion by ply-bonding and/or lamination between the two layers occurring at the peaks of these protuberances. In this condition the web material N stays against the surface of the cylinder 3 and is fed through the embossing nip 9 where both layers V1 and V2 undergo an embossing action producing deformation in a direction perpendicular to the surface of the layers. As it leaves the embossing nip 9 the web material N is seen to be deformed as visible in FIG. 9. Both layers V1 and V2 have protuberances denoted P1 and P2, respectively, the protuberances P1 being directed inward between the two layers and fitting between the protuberances P2, which project outward from the product. The protuberances P1 and P2 are taller than the protuberances P generated in the lamination nip 5 because of the resilience of the covering 7A of the pressure roller 7.

This produces two results: in the first place the greater height of the protuberances P1, P2 restores the apparent thickness of the product M at the edges, so that the pack PM of products will no longer assume the irregular shape seen in FIG. 6, but rather will be a regular parallelepiped (insofar as is compatible with the soft and flexible nature of the material of the products). In the second place the deformation produced by the embossing in the nip 9 is of roughly the same order of magnitude for both layers V1 and V2, eliminating the tendency of the margins of the product to lift.

In this way all or some of the drawbacks described above as being typical of conventional devices are eliminated.

The pressure between the roller 7 and the cylinder 3 on the one hand and the softness of the covering 7A on the other are chosen such as to give the two layers V1, V2 the necessary amount of deformation. The covering may have a hardness of for example approximately 50 Shore A degrees, although this value should be understood to be purely an indication and not restrictive.

The product obtained is therefore differentiated from those obtained with prior-art devices in that in the processed area along the edges, the two layers are not only united by local compression, that is by ply-bonding or lamination, but also further embossed with a more pronounced deformation of both the layers and to a design that corresponds to that of the lamination or ply-bonding.

It will be understood that the drawing shows only a practical embodiment which can be varied in its shapes and arrangements without thereby departing from the scope of the concept on which the invention is based. The presence of any reference numerals in the appended claims is purely for the purpose of facilitating their reading in the light of the description and of the accompanying drawings, and in no way limits the scope of protection represented thereby.

1. Device for joining at least two layers (V1, V2) for forming a multilayer web product (N), comprising a rigid first cylinder (1) and a rigid second cylinder (3), the latter having protuberances (3P), said first and second cylinders rotating in opposite directions about respective axes of rotation (1A, 3A), and defining between themselves a first nip (5), and further comprising a pressure roller (7), with a resilient surface (7A), that is less rigid than said first and second cylinders (1, 3), said roller interacting with said second cylinder (3) and means being provided to press said pressure roller (7) and said second cylinder (3) against each other, said pressure roller forming with said second cylinder (3) an embossing nip (9) arranged downstream of said first nip with respect to the direction of rotation of said second cylinder (3), characterized in that: said first cylinder (1) is smooth and means are provided to press said first cylinder (1) and said second cylinder (3) against each other with a pressure such as to produce a localized mutual adhesion of the two layers passing through said first lamination and ply-bonding nip (5), due to a mingling of the fibers of the two layers; said two previously laminated and ply-bonded layers being passed and embossed in said embossing nip (5).

2. Device according to claim 1, characterized in that said protuberances (3P) are arranged on said second cylinder (3) according to longitudinal bands parallel to the axis (3A) of said cylinder and to circumferential annular bands.

3. Device according to claim 1 or 2, characterized in that said pressure roller has a rubber coating (7A).

4. Device according to claim 1 or 2 or 3, characterized in that the protuberances (3P) on said second cylinder (3) are arranged in circumferential and longitudinal bands in order to generate on said web product (N) areas (G) of lamination and embossing in longitudinal and transverse bands.

5. Method for producing a web product comprising at least a first and a second layer (V1, V2), in which said first and second layers are united by lamination at a plurality of spots, wherein said first and second layers are laminated in a nip (5) between a first cylinder and a rigid second cylinder (3), the latter having protuberances (3P), said cylinders being pressed against each other, and the two layers are embossed between said second cylinder (3) and a pressure roller (7) which are pressed against each other, said pressure roller having a resilient surface (7A),
characterized in that said first cylinder (1) is rigid and smooth and that said first and second cylinder (1, 3) are pressed against each other with a pressure such as to produce a localized mutual adhesion of the two layers due to a mingling of the fibers of the two layers in said lamination spots corresponding to said protuberances (3P), the bonded plies being embossed between said second cylinder (3) and said pressure roller (7) according to a design corresponding to the distribution of the lamination spots.

6. Method according to claim 5, characterized in that said first and second layers are united by lamination and then embossed along longitudinal and transverse bands.

7. Method according to claim 5 or 6, characterized in that said web material (No) is divided into individual products (M) by cut lines ex ending along said longitudinal and transverse bands, the individual products then being folded.

8. Method according to claim 5, 6, or 7, characterized in that said layers are embossed so that protuberances (P) of between 0.1 and 1 mm in height are produced on them.

9. A sheet product (M) comprising at least two layers (V1, V2) united along peripheral bands (G) along which said layers are embossed with embossing design protrusions (P1, P2), said layers being bonded to each other along said bands, characterized in that said layers are additionally ply-bonded by mingling of the fibers of the two layers in localized ply-bonding compression areas, said areas having a distribution corresponding to that of said embossing design protrusions.

10. Product according to claim 9, characterized in that the layers have protuberances with a height of between 0.1 and 1 mm along said peripheral bands.
